(19) United States
(12) Patent Application Publication
(10) Pub. No.: US 2025/0145098 A1
(43) Pub. Date: May 8, 2025

(54) BUMPER REINFORCEMENT MEMBER AND METHOD FOR MANUFACTURING SAME

(71) Applicant: Kabushiki Kaisha Kobe Seiko Sho (Kobe Steel, Ltd.), Kobe-shi (JP)

(72) Inventors: Taiki YAMAKAWA, Shimonoseki-shi (JP); Hideki ISHITOBI, Shimonoseki-shi (JP)

(73) Assignee: Kabushiki Kaisha Kobe Seiko Sho (Kobe Steel, Ltd.), Kobe-shi (JP)

(21) Appl. No.: 18/836,839

(22) PCT Filed: Jan. 13, 2023
(86) PCT No.: PCT/JP2023/000801

§ 371 Date: Aug. 8, 2024

(30) Foreign Application Priority Data
Feb. 10, 2022 (JP) 2022-019654

(51) Int. Cl. B60R 19/18; B60R 19/03

(52) U.S. Cl. CPC B60R 19/18; B60R 19/03

(57) ABSTRACT

A bumper reinforcement member is made of an aluminum alloy extruded shape material and having an outer flange and inner flange separated from each other by a first flange distance. A first outer connection portion is separated from a second outer connection portion by an outer web distance shorter than the first flange distance, and the first inner connection portion is separated from the second inner connection portion by an inner web distance shorter than the first flange distance. The first web and the second web are respectively curved so as to have protruding shapes facing each other at both the end portions.

### TECHNICAL FIELD

The present disclosure relates to a bumper reinforcement member and a method for manufacturing the same.

### BACKGROUND ART

From a viewpoint of design, the bumper reinforcement member disposed at a vehicle front end portion may be subjected to crushing processing so that a distance between flanges is reduced at both ends. On the other hand, even the portion subjected to the crushing processing is required to have a certain impact resistance so as to be able to withstand a collision or the like from a diagonal front of the vehicle.

Patent Document 1 describes a bumper reinforcement member in which a web is processed so that a number of support points of the web with respect to a flange increases at the time of collision in a portion subjected to crushing processing. By increasing the number of support points of the web with respect to the flange, the rigidity of the flange may be improved, and the impact resistance of the bumper reinforcement member may be improved.

### PRIOR ART DOCUMENT

### Patent Document

Patent Document 1: JP 2020-142764 A

### SUMMARY OF THE INVENTION

### Problems to be Solved by the Invention

However, in the bumper reinforcement member described in Patent Document 1, the distance between the webs is large, and there is no particular suggestion about the support structure between the webs which can have a higher effect in terms of improving the impact resistance of the bumper reinforcement member, and there is room for improvement.

An object of the present disclosure is to improve impact resistance in a portion subjected to crushing processing in a bumper reinforcement member.

### Solutions to the Problems

A first aspect of the present disclosure provides a bumper reinforcement member made of an aluminum alloy extruded shape material extending along a vehicle left-right direction, comprising: an outer flange and an inner flange separated from each other in a vehicle front-rear direction; a web group connecting the outer flange and the inner flange; a central portion in which the outer flange and the inner flange are separated from each other by a first flange distance, the central portion being a portion positioned at a center in the vehicle left-right direction; and both end portions in which the outer flange and the inner flange are separated from each other by a second flange distance shorter than the first flange distance, each of both the end portions being a portion positioned at either end in the vehicle left-right direction. The web group includes: a first web connected to the outer flange at a first outer connection portion and connected to the inner flange at a first inner connection portion, and a second web adjacent to the first web, connected to the outer flange at a second outer connection portion, and connected to the inner flange at a second inner connection portion. In a vehicle vertical direction, the first outer connection portion is separated from the second outer connection portion by an outer web distance shorter than the first flange distance, and the first inner connection portion is separated from the second inner connection portion by an inner web distance shorter than the first flange distance. The first web and the second web are respectively curved so as to have protruding shapes facing each other at both the end portions.

According to the above configuration, along with the fact that an impact load is applied to both the end portions and the outer flange and the inner flange at both the end portions are deformed so as to approach each other, the first web and the second web can be deformed so as to be in contact with each other. After the first web and the second web are deformed to be in contact with each other, the deformation of the first web can be suppressed by the second web. Similarly, the deformation of the second web can be suppressed by the first web. In other words, the first web and the second web support each other so as not to mutually fall over, and a support structure between the webs can be configured. Therefore, the deformation in which the outer flange and the inner flange at both the end portions approach each other is suppressed, and the impact resistance of the bumper reinforcement member can be improved.

The outer web distance may be shorter than the second flange distance, and the inner web distance may be shorter than the second flange distance.

According to the above configuration, since the distance between the first web and the second web is short, it is possible to form a strong support structure between the webs.

The first web may include a first protruding portion closest to the second web at both the end portions. The second web may include a second protruding portion closest to the first web at both the end portions. The first protruding portion and the second protruding portion may be respectively positioned at an identical distance from the outer flange in a cross-section perpendicular to an extending direction of the aluminum alloy extruded shape material.

According to the above configuration, by the first protruding portion and the second protruding portion, the first web and the second web can be supported by each other so as not to fall over each other. Therefore, each of the first web and the second web is less likely to fall over, and the impact resistance of the bumper reinforcement member can be improved. In addition, the loads in the directions normal to the respective first web and second web cancel each other at the first protruding portion and the second protruding portion. Therefore, the impact resistance of the bumper reinforcement member can be improved.

The first protruding portion and the second protruding portion may be in contact with each other.

According to the above configuration, even before an impact load is applied, the first protruding portion and the second protruding portion are in contact with each other. Therefore, it is possible to suppress the occurrence of deviation when the first web and the second web support each other.

Both the end portions may be bent toward a vehicle body.

According to the above configuration, a wide range of the front portion of the vehicle body can be protected by the bumper reinforcement member. Therefore, the vehicle body protection performance of the bumper reinforcement member can be improved.

A second aspect of the present disclosure provides a method for manufacturing a bumper reinforcement member, the method including: extruding an aluminum alloy extruded shape material, the aluminum alloy extruded shape material including: an outer flange and an inner flange separated from each other by a first flange distance in a vehicle front-rear direction; and a web group including a first web connected to the outer flange at a first outer connection portion and connected to the inner flange at a first inner connection portion, and a second web adjacent to the first web, connected to the outer flange at a second outer connection portion, and connected to the inner flange at a second inner connection portion, wherein the first outer connection portion is separated from the second outer connection portion by an outer web distance shorter than the first flange distance in an in-plane direction of the outer flange, and the first inner connection portion is separated from the second inner connection portion by an inner web distance shorter than the first flange distance in an in-plane direction of the inner flange; performing crushing processing on both ends of the aluminum alloy extruded shape material so that a distance between the outer flange and the inner flange is reduced to a second flange distance and so that the first web and the second web have protruding shapes facing each other; and applying precipitation strengthening heat treatment to the aluminum alloy extruded shape material.

According to the above configuration, along with the fact that an impact load is applied to both the end portions and the outer flange and the inner flange at both the end portions are deformed so as to approach each other, the first web and the second web can be deformed so as to be in contact with each other. After the first web and the second web are deformed to be in contact with each other, the deformation of the first web can be suppressed by the second web. Similarly, the deformation of the second web can be suppressed by the first web. In other words, the first web and the second web support each other so as not to mutually fall over, and a support structure between the webs can be configured. Therefore, the deformation in which the outer flange and the inner flange at both the end portions approach each other is suppressed, and the impact resistance of the bumper reinforcement member can be improved.

The outer web distance may be shorter than the second flange distance, and the inner web distance may be shorter than the second flange distance.

According to the above configuration, since the distance between the first web and the second web is short, it is possible to form a stronger support structure between the webs.

The aluminum alloy extruded shape material may be heated to be in a warm state after the aluminum alloy extruded shape material is extruded and before both the ends are subjected to crushing processing.

According to the above configuration, by bringing the aluminum alloy extruded shape material into the warm state, the timing of performing the crushing processing can be optionally set. Therefore, manufacturing management can be facilitated.

The aluminum alloy extruded shape material may be subjected to softening heat treatment after the aluminum alloy extruded shape material is extruded and before both the ends are subjected to crushing processing.

According to the above configuration, by subjecting the aluminum alloy extruded shape material to the softening heat treatment, it is possible to optionally set the timing of performing the crushing processing. Therefore, manufacturing management can be facilitated.

### Effects of the Invention

According to the bumper reinforcement member of the present disclosure, it is possible to improve impact resistance in a portion subjected to crushing processing.

### BRIEF DESCRIPTION OF THE DRAWINGS

FIG. 1 is a plan view of a bumper system according to a first embodiment of the present invention;

FIG. 2 is an end view taken along line II-II in FIG. 1;

FIG. 3 is an end view taken along line III-III in FIG. 1;

FIG. 4 is a front view of a manufacturing apparatus that executes a first step of the method for manufacturing a bumper beam;

FIG. 5 is a plan view of a manufacturing apparatus that executes a second step of the method for manufacturing the bumper beam;

FIG. 6 is a side view of a manufacturing apparatus that executes a third step of the method for manufacturing the bumper beam;

FIG. 7 is an end view similar to FIG. 3 after the bumper beam is crushed;

FIG. 8 is an end view of both end portions when an impact is applied to the bumper beam;

FIG. 9 is an end view similar to FIG. 2 in a second embodiment;

FIG. 10 is an end view similar to FIG. 3 in the second embodiment;

FIG. 11 is an end view similar to FIG. 2 in a third embodiment;

FIG. 12 is an end view similar to FIG. 3 in the third embodiment;

FIG. 13 is an end view similar to FIG. 2 in a fourth embodiment;

FIG. 14 is an end view similar to FIG. 3 in the fourth embodiment

FIG. 15 is an end view similar to FIG. 2 in a fifth embodiment;

FIG. 16 is an end view similar to FIG. 3 in the fifth embodiment;

FIG. 17 is an end view similar to FIG. 2 in a sixth embodiment;

FIG. 18 is an end view similar to FIG. 3 in the sixth embodiment;

FIG. 19 is an end view similar to FIG. 2 in a seventh embodiment; and

FIG. 20 is an end view similar to FIG. 3 in the seventh embodiment.

### DETAILED DESCRIPTION

### First Embodiment

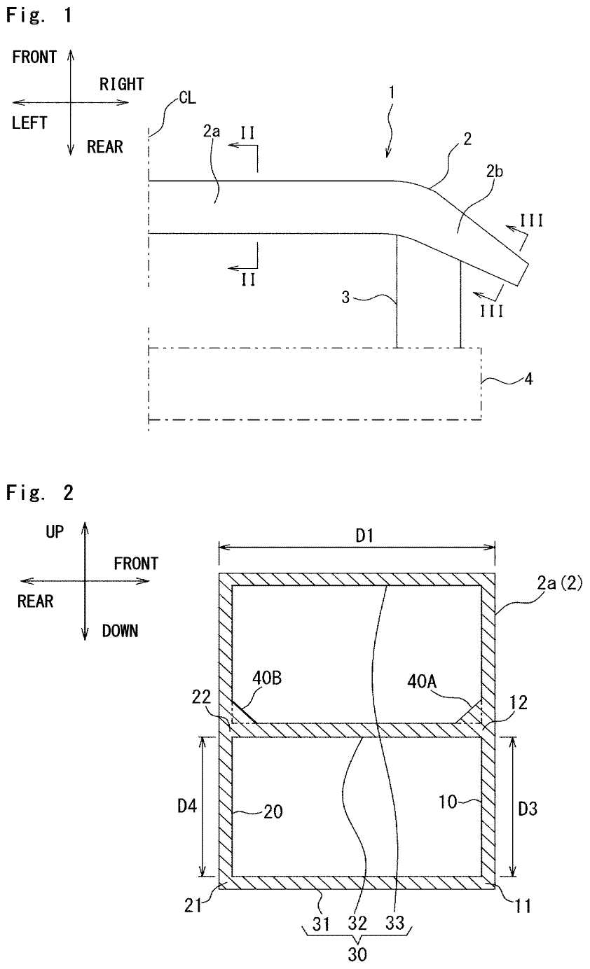

FIG. 1 is a plan view of a bumper system 1 including a bumper beam (bumper reinforcement member) 2 and a bumper stay 3 in the present embodiment. In FIG. 1, the vehicle front-rear direction is indicated by a front and rear double-pointed arrow, and the vehicle left-right direction is indicated by a left and right double-pointed arrow. In FIG. 2 and subsequent figures, the vehicle vertical direction is indicated by an up and down double-pointed arrow. The bumper system 1 is configured symmetrically with respect to a center line CL passing through the center in the vehicle left-right direction, but illustration of the left side is omitted. In addition, in FIG. 1, the vehicle body 4 is simply illustrated by a two-dot chain line. The bumper beam 2 is fixed to the front side in the vehicle front-rear direction of the vehicle body 4 through the bumper stay 3.

The bumper beam 2 is made of an aluminum alloy extruded shape material and extends along the vehicle left-right direction. In addition, the bumper beam 2 has a central portion 2a positioned at the center in the vehicle left-right direction and both end portions 2b positioned at both ends in the vehicle left-right direction. In the present embodiment, both the end portions 2b are bent toward the vehicle body 4. Both the end portions 2b do not need to be bent in the vehicle body 4, that is, may be at the same position as the central portion 2a in the vehicle vertical direction and the vehicle front-rear direction.

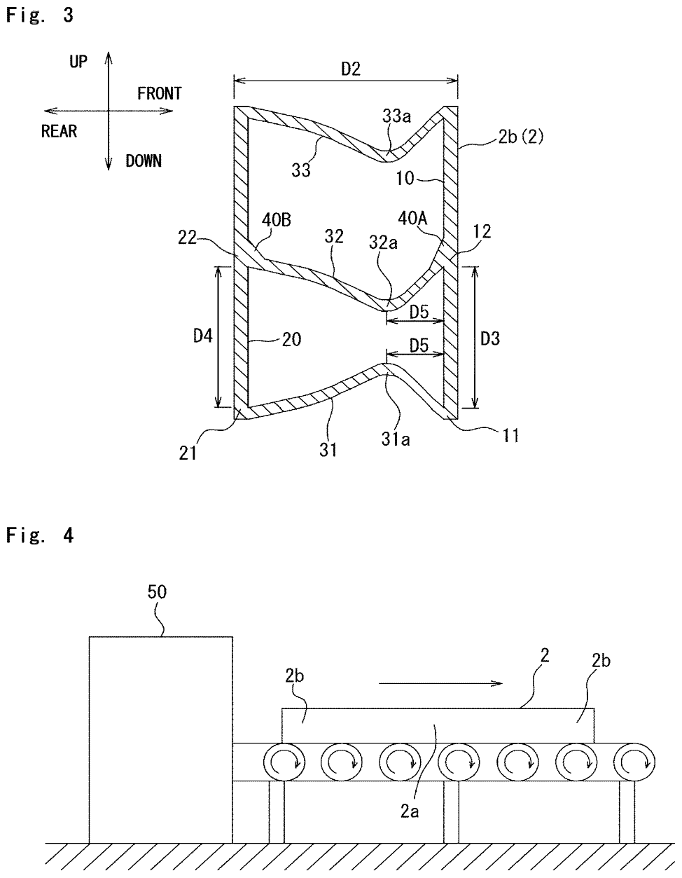

Referring also to FIGS. 2 and 3, the bumper beam 2 includes an outer flange 10, an inner flange 20 and a web group 30. The outer flange 10 and the inner flange 20 are separated from each other in the vehicle front-rear direction. The web group 30 connects the outer flange 10 and the inner flange 20.

In the present embodiment, the web group 30 includes a first web 31, a second web 32, and a third web 33. The first web 31 is positioned on the lowermost side in the vehicle vertical direction. The third web 33 is positioned on the uppermost side in the vehicle vertical direction. The second web 32 is positioned between the first web 31 and the third web 33 in the vehicle vertical direction. That is, the first web 31 and the second web 32 are adjacent to each other.

In the central portion 2a, the first web 31 and the second web 32 are arranged substantially parallel to each other, and the second web 32 and the third web 33 are also arranged substantially parallel to each other. The first web 31 is connected to the outer flange 10 at a first outer connection portion 11, and is connected to the inner flange 20 at a first inner connection portion 21. In addition, the second web 32 is connected to the outer flange 10 at a second outer connection portion 12, and is connected to the inner flange 20 at a second inner connection portion 22.

In the present embodiment, the second outer connection portion 12 is provided with a fillet 40A. As virtually indicated by a two-dot chain line in FIG. 2, the fillet 40A is configured as a substantially triangular thick portion in a cross-section perpendicular to the vehicle left-right direction, and is disposed on a side opposite to that of the first web 31 in the vehicle vertical direction (upper side in the vehicle vertical direction in FIG. 2) with respect to the second web 32. More specifically, the fillet 40A is provided so that one side of the triangle of the fillet 40A is in contact with the rear side in the vehicle front-rear direction of the outer flange 10 and the other side is in contact with the upper side in the vehicle vertical direction of the second web 32. Similarly, the second inner connection portion 22 is provided with a fillet 40B.

In the present embodiment, in the vehicle vertical direction, that is, in the in-plane direction of the outer flange 10, the first outer connection portion 11 is separated from the second outer connection portion 12 by the outer web distance D3. In the vehicle vertical direction, that is, in the in-plane direction of the inner flange 20, the first inner connection portion 21 is separated from the second inner connection portion 22 by the inner web distance D4. In the present embodiment, the outer web distance D3 and the inner web distance D4 are the same length.

Referring to FIG. 2, the outer flange 10 and the inner flange 20 are separated from each other by a first flange distance D1 in the central portion 2a. The outer web distance D3 and the inner web distance D4 are each shorter than the first flange distance D1 (D3<D1, D4<D1). That is, when viewed from the vehicle left-right direction, a rectangle is formed that is long in the vehicle front-rear direction with the first outer connection portion 11, the second outer connection portion 12, the first inner connection portion 21, and the second inner connection portion 22 as vertices.

Referring to FIG. 3, the outer flange 10 and the inner flange 20 are separated from each other at both the end portions 2b by a second flange distance D2 shorter than the first flange distance D1 (D2<D1). In addition, in the present embodiment, the outer web distance D3 and the inner web distance D4 are each shorter than the second flange distance D2 (D3<D2, D4<D2). That is, when viewed from the vehicle left-right direction, a rectangle is virtually formed that is long in the vehicle front-rear direction with the first outer connection portion 11, the second outer connection portion 12, the first inner connection portion 21, and the second inner connection portion 22 as vertices.

In the present embodiment, the first web 31 and the second web 32 are each curved so as to have protruding shapes facing each other at both the end portions 2b. Specifically, the first web 31 has a first protruding portion 31a closest to the second web 32 at both the end portions 2b. In addition, the second web 32 has a second protruding portion 32a closest to the first web 31 at both the end portions 2b. The first protruding portion 31a and the second protruding portion 32a are each positioned at the same distance from the outer flange 10 in a cross-section perpendicular to the extending direction of the bumper beam 2. That is, the first protruding portion 31a is disposed at a position of a protruding portion distance D5 from the outer flange 10 in the vehicle front-rear direction, and the second protruding portion 32a is disposed at a position of a protruding portion distance D5 from the outer flange 10 in the vehicle front-rear direction.

In addition, in the present embodiment, the third web 33 is curved so as to have a protruding shape toward the second web 32 at both the end portions 2b. That is, the third web 33 has a third protruding portion 33a.

Hereinafter, a method for manufacturing the bumper beam 2 in the present embodiment will be described with reference to FIGS. 4 to 7.

Referring to FIG. 4, in the first step, the bumper beam 2 in the present embodiment is extruded by the extruder 50 and cut at any length. Both the end portions 2b of the bumper beam 2 at this stage are not subjected to bending processing, and are not subjected to crushing processing either.

Referring to FIG. 5, in the second step, both the end portions 2b of the extruded bumper beam 2 are subjected to bending processing by a bending machine 51. In the present embodiment, the bending processing in the second step is performed while natural aging occurs.

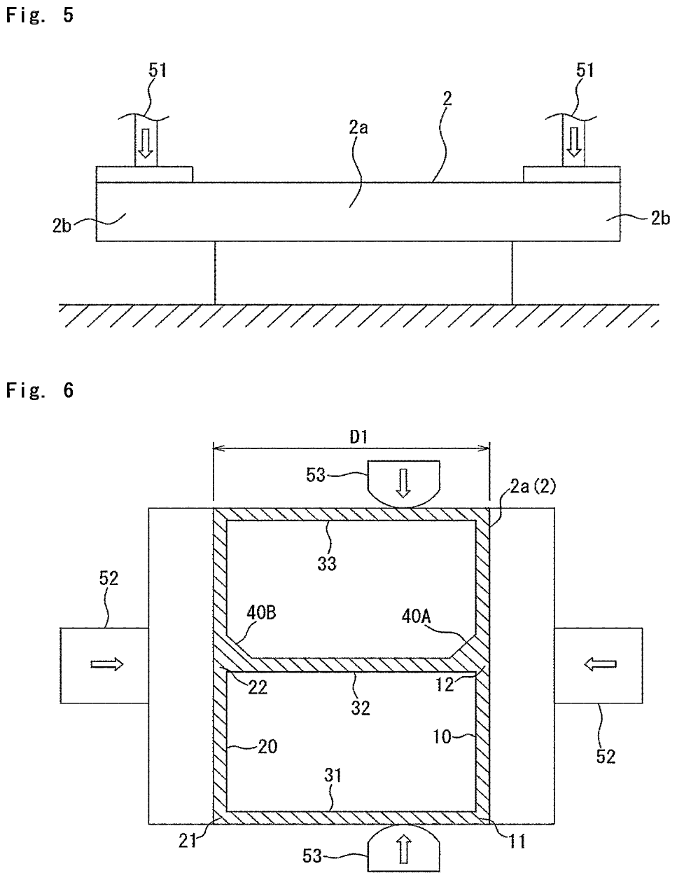

Referring to FIG. 6, in the third step, both the end portions 2b are subjected to crushing processing. The crushing processing in the present embodiment is classified into warm working. That is, after the bumper beam 2 is brought into a warm state by heating the bumper beam 2 to, for example, 200° C. to 400° C., crushing processing is performed. In other words, after the bumper beam 2 is extruded and before both the end portions 2b are crushing processed, the bumper beam 2 is heated and brought into a warm state.

As a modification of the third step, the crushing may not be performed in the warm state, and may be performed after softening heat treatment is performed on the bumper beam 2. That is, the softening heat treatment may be performed on the bumper beam 2 after the bumper beam 2 is extruded and before both the end portions 2b are crushing processed. In this case, by applying the softening heat treatment to the bumper beam 2, the timing of performing the crushing processing can be optionally set. Therefore, manufacturing management can be facilitated. It should be noted that the softening heat treatment is a treatment for softening the bumper beam 2 by cooling, preferably rapidly cooling, the bumper beam 2 heated to a predetermined temperature, for example, 300° C. to 600° C.

In addition, the first step to the third step may be completed before the natural aging is completed. Specifically, the first step to the third step may be completed within two hours. In this case, when the crushing processing is applied to both the end portions 2b, the step of heating the bumper beam 2 may be omitted.

In the present embodiment, crushing processing is performed by the first pressing machine 52 and the second pressing machine 53. The first pressing machine 52 presses the substantially entire surface of each of the outer flange 10 and the inner flange 20 from the outside so as to reduce the distance between the outer flange 10 and the inner flange 20 from the first flange distance D1 to the second flange distance D2. The second pressing machine 53 presses parts of the first web 31 and the third web 33 from the outside toward the inside.

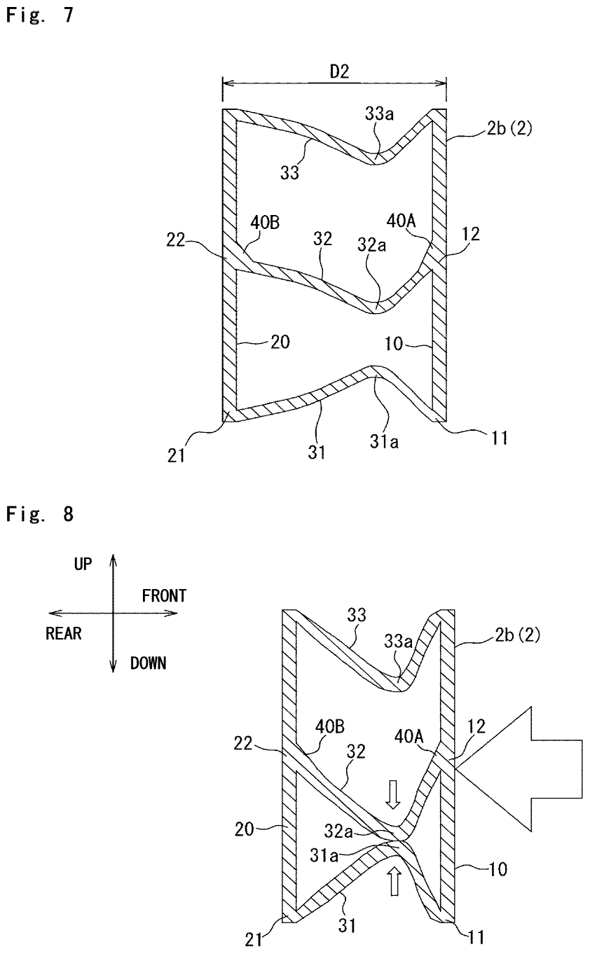

Referring also to FIG. 7, by simultaneously performing pressing by the first pressing machine 52 and pressing by the second pressing machine 53, the first web 31 and the third web 33 are curved so as to have protruding shapes toward the inside.

At the time of the crushing processing, since the fillets 40A and 40B are provided, the second web 32 is curved so as to have a protruding shape toward the first web 31. Specifically, since the second web 32 is prevented from deforming toward the third web 33 by the fillets 40A and 40B, the second web 32 is curved so as to have a protruding shape toward the first web 31.

As described above, at both the end portions 2b, the crushing processing is performed so as to reduce the distance between the outer flange 10 and the inner flange 20 to the second flange distance D2 so that the first web 31 and the second web 32 have protruding shapes facing each other.

After completion of the crushing processing in the third step, precipitation strengthening heat treatment is performed on the bumper beam 2. The strength of the bumper beam 2 can be improved by the precipitation strengthening heat treatment.

FIG. 8 is a view showing the deformation of both the end portions 2b due to the application of an impact from the front side in the vehicle front-rear direction to the outer flange 10 at both the end portions 2b of the bumper beam 2. The application of the impact causes the outer flange 10 and the inner flange 20 to further approach each other. On this occasion, the first web 31 and the second web 32 are deformed so that the first protruding portion 31a and the second protruding portion 32a are in contact with each other.

According to the present embodiment, along with the fact that an impact load is applied to both the end portions 2b and the outer flange 10 and the inner flange 20 at both the end portions 2b are deformed so as to approach each other, the first web 31 and the second web 32 can be deformed so as to be in contact with each other. After the first web 31 and the second web 32 are deformed to be in contact with each other, the deformation of the first web 31 can be suppressed by the second web 32. Similarly, the deformation of the second web 32 can be suppressed by the first web 31. In other words, the first web 31 and the second web 32 support each other so as not to mutually fall over, and a support structure between the webs can be configured. Therefore, the deformation in which the outer flange 10 and the inner flange 20 at both the end portions 2b approach each other is suppressed, and the impact resistance of the bumper beam 2 can be improved.

In addition, in the present embodiment, the outer web distance D3 and the inner web distance D4 are smaller than the second flange distance D2. That is, the distance between the first web 31 and the second web 32 is short. Therefore, it is possible to form a strong support structure between webs.

Furthermore, by the first protruding portion 31a and the second protruding portion 32a, the first web 31 and the second web 32 can be supported by each other so as not to fall over each other. Therefore, each of the first web 31 and the second web 32 is less likely to fall over, and the impact resistance of the bumper beam 2 can be improved. In addition, the loads in the directions normal to the respective first web 31 and second web 32 cancel each other at the first protruding portion 31a and the second protruding portion 32a. Therefore, the impact resistance of the bumper beam 2 can be improved.

In the bumper beam 2 in the present embodiment, both the end portions 2b are bent toward the vehicle body 4. For this reason, a wide range of the front portion of the vehicle body 4 can be protected by the bumper beam 2. Therefore, the vehicle body protection performance of the bumper beam 2 can be improved.

In addition, by bringing the bumper beam 2 into the warm state, the timing of performing the crushing processing can be optionally set. Therefore, manufacturing management can be facilitated.

### Second Embodiment

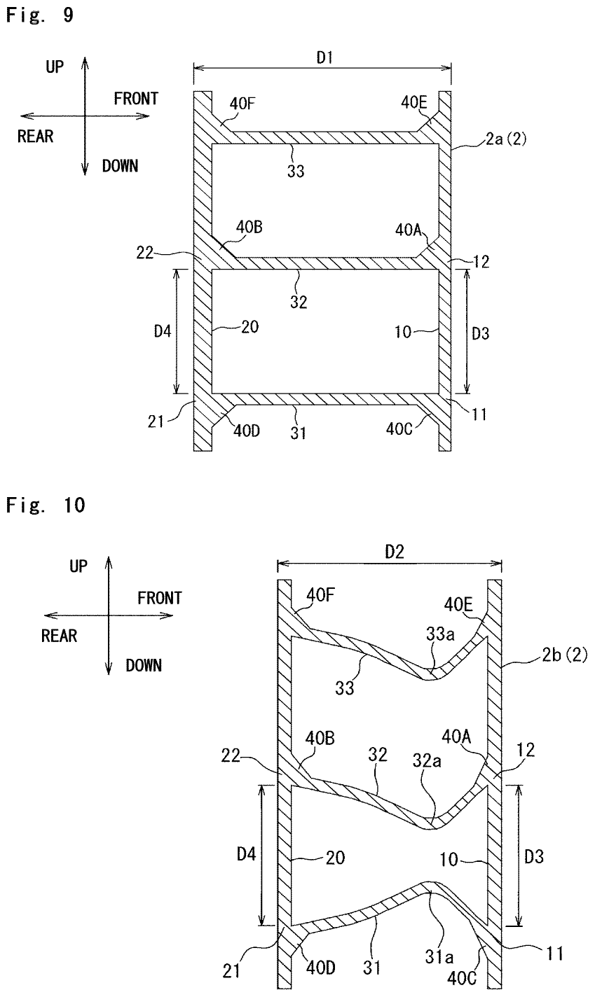

Referring to FIGS. 9 and 10, a configuration of a bumper beam 2 according to a second embodiment of the present invention is different from that of the first embodiment in the following points. Other configurations of the second embodiment are similar to those of the first embodiment, and the elements identical or similar to those of the first embodiment are denoted by the same reference numerals.

Referring to FIG. 9, in the bumper beam 2 according to the second embodiment, fillets 40C and 40D are provided on the lower side in the vehicle vertical direction of the first web 31. In addition, fillets 40E and 40F are provided also on the upper side in the vehicle vertical direction of the third web 33. The fillets 40C, 40D, 40E, and 40F have the same configuration as that of the fillet 40A.

Referring to FIG. 10, in the bumper beam 2 after the crushing processing at both the end portions 2b, the first web 31 is curved so as to have a protruding shape toward the second web 32. The second web 32 is curved so as to have a protruding shape toward the first web 31. The third web 33 is curved so as to have a protruding shape toward the second web 32.

According to the bumper beam 2 of the second embodiment, by pressing each of the outer flange 10 and the inner flange 20 from the outside, the first web 31 and the second web 32 are curved so as to have protruding shapes facing each other. That is, the crushing processing can be performed without using the second pressing machine 53 (see FIG. 6).

### Third Embodiment

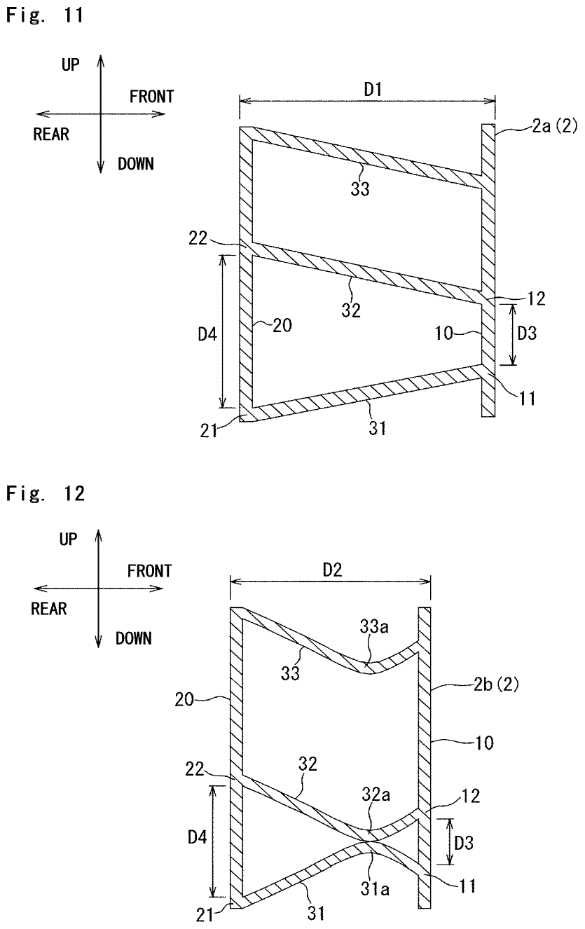

Referring to FIGS. 11 and 12, a configuration of a bumper beam 2 according to a third embodiment of the present invention is different from that of the first embodiment in the following points. Other configurations of the third embodiment are similar to those of the first embodiment, and the elements identical or similar to those of the first embodiment are denoted by the same reference numerals.

Referring to FIG. 11, in the bumper beam 2 in the third embodiment, fillets 40A and 40B (see FIG. 2 and the like) are not arranged. In addition, the first web 31, the second web 32, and the third web 33 are arranged obliquely with respect to the vehicle front-rear direction. Specifically, the first outer connection portion 11 is disposed on the upper side in the vehicle vertical direction of the first inner connection portion 21. In addition, the second outer connection portion 12 is disposed on the lower side in the vehicle vertical direction of the second inner connection portion 22. That is, the first web 31 and the second web 32 are disposed so that the outer web distance D3 is shorter than the inner web distance D4. In addition, the third web 33 is disposed so as to be substantially parallel to the second web 32.

Referring to FIG. 12, in the bumper beam 2 after the crushing processing at both the end portions 2b, the first web 31 is curved so as to have a protruding shape toward the second web 32. The second web 32 is curved so as to have a protruding shape toward the first web 31. The third web 33 is curved so as to have a protruding shape toward the second web 32.

In the third embodiment, the first protruding portion 31a and the second protruding portion 32a are in contact with each other at the stage of the crushing processing.

According to the bumper beam 2 of the third embodiment, by pressing each of the outer flange 10 and the inner flange 20 from the outside, the first web 31 and the second web 32 are curved so as to have protruding shapes facing each other. That is, the crushing processing can be performed without using the second pressing machine 53 (see FIG. 6).

In addition, even before an impact load is applied, the first protruding portion 31a and the second protruding portion 32a are in contact with each other. Therefore, it is possible to suppress the occurrence of deviation when the first web 31 and the second web 32 support each other.

### Fourth Embodiment

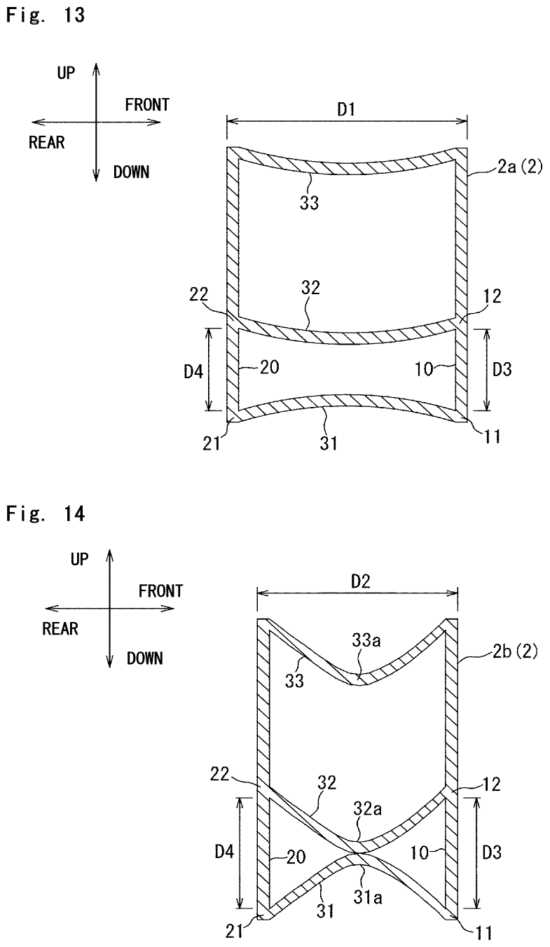

Referring to FIGS. 13 and 14, a configuration of a bumper beam 2 according to a fourth embodiment of the present invention is different from that of the first embodiment in the following points. Other configurations of the fourth embodiment are similar to those of the first embodiment, and the elements identical or similar to those of the first embodiment are denoted by the same reference numerals.

Referring to FIG. 13, in the bumper beam 2 in the fourth embodiment, fillets 40A and 40B (see FIG. 2 and the like) are not arranged. In addition, the first web 31, the second web 32, and the third web 33 are curved at the central portion 2a, that is, at the stage of having been extruded. Specifically, the first web 31 is curved so as to have a protruding shape toward the second web 32. The second web 32 is curved so as to have a protruding shape toward the first web 31. The third web 33 is curved so as to have a protruding shape toward the second web 32.

Referring to FIG. 14, in the bumper beam 2 after the crushing processing at both the end portions 2b, the first web 31 is further curved so as to have a protruding shape toward the second web 32. The second web 32 is further curved so as to have a protruding shape toward the first web 31. The third web 33 is further curved so as to have a protruding shape toward the second web 32.

In the fourth embodiment, the first protruding portion 31a and the second protruding portion 32a are in contact with each other at the stage of the crushing processing.

According to the bumper beam 2 of the fourth embodiment, by pressing each of the outer flange 10 and the inner flange 20 from the outside, the first web 31 and the second web 32 are curved so as to have protruding shapes facing each other. That is, the crushing processing can be performed without using the second pressing machine 53 (see FIG. 6).

In addition, even before an impact load is applied, the first protruding portion 31a and the second protruding portion 32a are in contact with each other. Therefore, it is possible to suppress the occurrence of deviation when the first web 31 and the second web 32 support each other.

### Fifth Embodiment

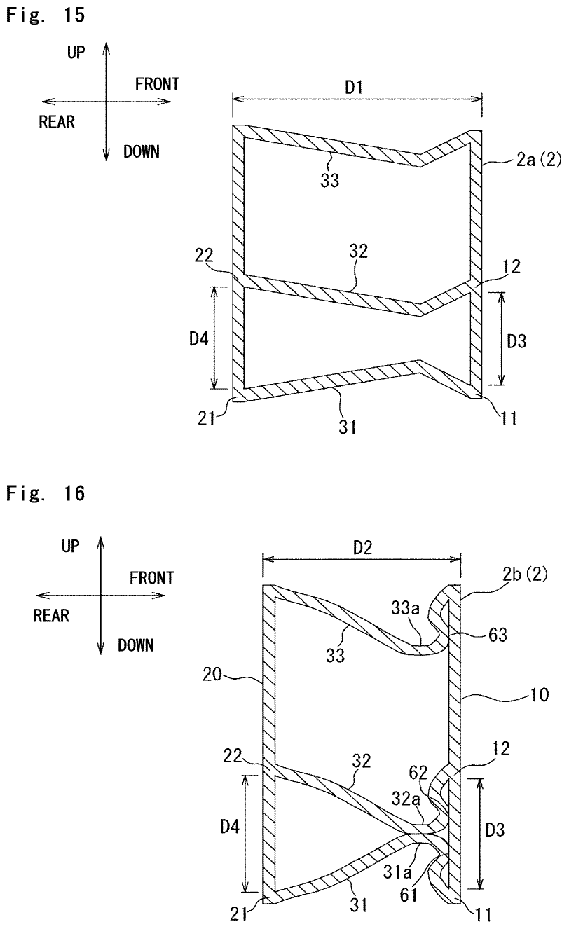

Referring to FIGS. 15 and 16, a configuration of a bumper beam 2· according to a fifth embodiment of the present invention is different from that of the first embodiment in the following points. Other configurations of the fifth embodiment are similar to those of the first embodiment, and the elements identical or similar to those of the first embodiment are denoted by the same reference numerals.

Referring to FIG. 15, in the bumper beam 2 in the fifth embodiment, fillets 40A and 40B (see FIG. 2 and the like) are not arranged. In addition, the first web 31, the second web 32, and the third web 33 are bent at the central portion 2a, that is, at the stage of having been extruded. Specifically, the first web 31 is bent so as to have a protruding shape toward the second web 32. The second web 32 is bent so as to have a protruding shape toward the first web 31. The third web 33 is bent so as to have a protruding shape toward the second web 32.

Referring to FIG. 16, in the bumper beam 2 after the crushing processing at both the end portions 2b, the first web 31 is curved so as to have a protruding shape toward the second web 32 and to have a first contact portion 61 in contact with the outer flange 10. The second web 32 is curved so as to have a protruding shape toward the first web 31 and to have a second contact portion 62 in contact with the outer flange 10. The third web 33 is curved so as to have a protruding shape toward the second web 32 and to have a third contact portion 63 in contact with the outer flange 10.

In the fifth embodiment, the first protruding portion 31a and the second protruding portion 32a are in contact with each other at the stage of the crushing processing.

According to the bumper beam 2 of the fifth embodiment, by pressing each of the outer flange 10 and the inner flange 20 from the outside, the first web 31 and the second web 32 are curved so as to have protruding shapes facing each other. That is, the crushing processing can be performed without using the second pressing machine 53 (see FIG. 6).

In addition, at both the end portions 2b, the outer flange 10 is supported by the first contact portion 61, the second contact portion 62, and the third contact portion 63. Therefore, when an impact is applied to the outer flange 10 from the vehicle front-rear direction, the rigidity of the outer flange 10 can be improved.

Furthermore, even before an impact load is applied, the first protruding portion 31a and the second protruding portion 32a are in contact with each other. Therefore, it is possible to suppress the occurrence of deviation when the first web 31 and the second web 32 support each other.

### Sixth Embodiment

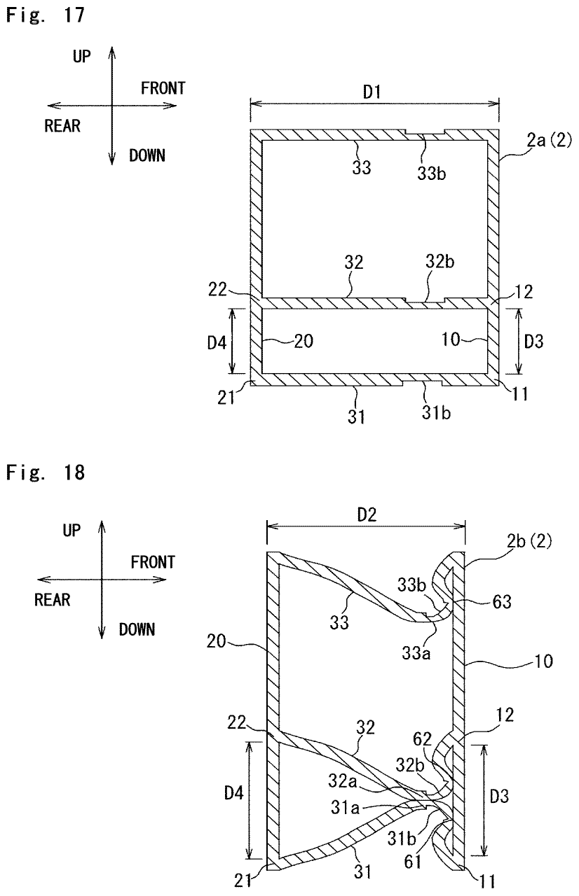

Referring to FIGS. 17 and 18, a configuration of a bumper beam 2 according to a sixth embodiment of the present invention is different from that of the first embodiment in the following points. Other configurations of the sixth embodiment are similar to those of the first embodiment, and the elements identical or similar to those of the first embodiment are denoted by the same reference numerals.

Referring to FIG. 17, in the bumper beam 2 in the sixth embodiment, fillets 40A and 40B (see FIG. 2 and the like) are not arranged. The first web 31, the second web 32, and the third web 33 are provided with notched portions 31b, 32b, and 33b. Specifically, the notched portion 31b is provided on the side opposite to that of the second web 32 (the lower side in the vehicle vertical direction in FIG. 17) in the vehicle vertical direction of the first web 31 and on the front side in the vehicle front-rear direction. The notched portion 32b is provided on the side opposite to that of the first web 31 (the upper side in the vehicle vertical direction in FIG. 17) in the vehicle vertical direction of the second web 32 and on the front side in the vehicle front-rear direction. The notched portion 33b is provided on the side opposite to that of the second web 32 (the upper side in the vehicle vertical direction in FIG. 17) in the vehicle vertical direction of the third web 33 and on the front side in the vehicle front-rear direction.

Referring to FIG. 18, in the bumper beam 2 after the crushing processing at both the end portions 2b, the first web 31 is curved so as to have a protruding shape toward the second web 32 and to have a first contact portion 61 in contact with the outer flange 10. The second web 32 is curved so as to have a protruding shape toward the first web 31 and to have a second contact portion 62 in contact with the outer flange 10. The third web 33 is curved so as to have a protruding shape toward the second web 32 and to have a third contact portion 63 in contact with the outer flange 10.

In the sixth embodiment, the first protruding portion 31a and the second protruding portion 32a are in contact with each other at the stage of the crushing processing. Similarly, the first contact portion 61 and the second contact portion 62 are also provided at the stage of crushing processing.

According to the bumper beam 2 of the sixth embodiment, by pressing each of the outer flange 10 and the inner flange 20 from the outside, the first web 31 and the second web 32 are curved so as to have protruding shapes facing each other. That is, the crushing processing can be performed without using the second pressing machine 53 (see FIG. 6).

In addition, at both the end portions 2b, the outer flange 10 is supported by the first contact portion 61, the second contact portion 62, and the third contact portion 63. Therefore, when an impact is applied to the outer flange 10 from the vehicle front-rear direction, the rigidity of the outer flange 10 can be improved.

Furthermore, even before an impact load is applied, the first protruding portion 31a and the second protruding portion 32a are in contact with each other. Therefore, it is possible to suppress the occurrence of deviation when the first web 31 and the second web 32 support each other.

### Seventh Embodiment

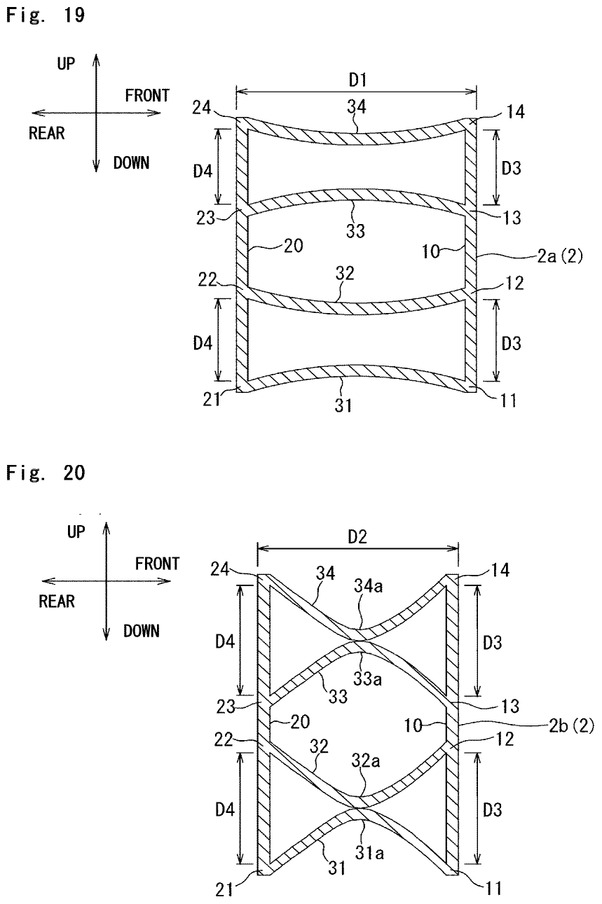

Referring to FIGS. 19 and 20, a configuration of a bumper beam 2 according to a seventh embodiment of the present invention is different from that of the first embodiment in the following points. Other configurations of the seventh embodiment are similar to those of the first embodiment, and the elements identical or similar to those of the first embodiment are denoted by the same reference numerals.

Referring to FIG. 19, in the bumper beam 2 in the seventh embodiment, fillets 40A and 40B (see FIG. 2 and the like) are not arranged. In addition, the bumper beam 2 in the seventh embodiment includes a fourth web 34. The fourth web 34 is disposed on the uppermost side in the vehicle vertical direction. That is, in the bumper beam 2 according to the seventh embodiment, the fourth web 34, the third web 33, the second web 32, and the first web 31 are arranged in this order from the upper side in the vehicle vertical direction.

In addition, in the bumper beam 2 according to the seventh embodiment, the first web 31, the second web 32, the third web 33, and the fourth web 34 are curved at the central portion 2a, that is, at the stage of having been extruded. Specifically, the first web 31 is curved so as to have a protruding shape toward the second web 32. The second web 32 is curved so as to have a protruding shape toward the first web 31. The third web 33 is curved so as to have a protruding shape toward the fourth web 34. The fourth web 34 is curved so as to have a protruding shape toward the third web 33.

In the seventh embodiment, the third web 33 is connected to the outer flange 10 at a third outer connection portion 13, and is connected to the inner flange 20 at a third inner connection portion 23. In addition, the fourth web 34 is connected to the outer flange 10 at a fourth outer connection portion 14, and is connected to the inner flange 20 at a fourth inner connection portion 24.

In the seventh embodiment, in the vehicle vertical direction, the third outer connection portion 13 is separated from the fourth outer connection portion 14 by the outer web distance D3. In addition, in the vehicle vertical direction, the fourth inner connection portion 24 is separated from the fourth inner connection portion 24 by an inner web distance D4.

Referring to FIG. 20, in the bumper beam 2 after the crushing processing at both the end portions 2b, the first web 31 is curved so as to have a protruding shape toward the second web 32 and so as to be in contact with the second web 32. The second web 32 is curved so as to have a protruding shape toward the first web 31 and so as to be in contact with the first web 31. The third web 33 is curved so as to have a protruding shape toward the fourth web 34 and so as to be in contact with the fourth web 34. The fourth web 34 is curved so as to have a protruding shape toward the third web 33 and so as to be in contact with the third web 33. That is, the fourth web 34 has a fourth protruding portion 34a.

According to the bumper beam 2 of the seventh embodiment, by pressing each of the outer flange 10 and the inner flange 20 from the outside, the first web 31 and the second web 32 are further curved so as to have protruding shapes facing each other. Furthermore, the third web 33 and the fourth web 34 are further curved so as to have protruding shapes facing each other. That is, the crushing processing can be performed without using the second pressing machine 53 (see FIG. 6).

In addition, even before the impact load is applied, the first protruding portion 31a and the second protruding portion 32a are in contact with each other, and the first protruding portion 31a and the second protruding portion 32a are in contact with each other. Therefore, it is possible to suppress the occurrence of deviation when the first web 31 and the second web 32 support each other, and it is possible to suppress the occurrence of deviation when the third web 33 and the fourth web 34 support each other.

Furthermore, since the number of webs is increased, the strength of the bumper beam 2 may be improved.

As described above, although the specific embodiments and their modifications of the present invention are described, the present invention is not limited to the above-described embodiments, and can be implemented with various modifications within the scope of the present invention. For example, an appropriate combination of contents of the individual embodiments may be one embodiment of the present invention. The bumper beam 2 may be arranged on the rear side in the vehicle front-rear direction, or may be applied to any other bumper.

The present disclosure may include the following aspects.

### (Aspect 1)

A bumper reinforcement member made of an aluminum alloy extruded shape material extending along a vehicle left-right direction, including:
an outer flange and an inner flange separated from each other in a vehicle front-rear direction; and
a web group connecting the outer flange and the inner flange;
a central portion in which the outer flange and the inner flange are separated from each other by a first flange distance, the central portion being a portion positioned at a center in the vehicle left-right direction; and
both end portions in which the outer flange and the inner flange are separated from each other by a second flange distance shorter than the first flange distance, each of both the end portions being a portion positioned at either end in the vehicle left-right direction,
wherein the web group includes:
a first web connected to the outer flange at a first outer connection portion and connected to the inner flange at a first inner connection portion; and
a second web adjacent to the first web, connected to the outer flange at a second outer connection portion, and connected to the inner flange at a second inner connection portion,
in a vehicle vertical direction, the first outer connection portion is separated from the second outer connection portion by an outer web distance shorter than the first flange distance, and the first inner connection portion is separated from the second inner connection portion by an inner web distance shorter than the first flange distance, and
the first web and the second web are respectively curved so as to have protruding shapes facing each other at both the end portions.

### (Aspect 2)

The bumper reinforcement member according to the aspect 1, wherein the outer web distance is shorter than the second flange distance, and the inner web distance is shorter than the second flange distance.

### (Aspect 3)

The bumper reinforcement member according to the aspect 1 or 2, wherein
the first web includes a first protruding portion closest to the second web at both the end portions,
the second web includes a second protruding portion closest to the first web at both the end portions, and
the first protruding portion and the second protruding portion are respectively positioned at an identical distance from the outer flange in a cross-section perpendicular to an extending direction of the aluminum alloy extruded shape material.

### (Aspect 4)

The bumper reinforcement member according to the aspect 3, wherein the first protruding portion and the second protruding portion are in contact with each other.

### (Aspect 5)

The bumper reinforcement member according to any one of the aspects 1 to 4, wherein both the end portions are bent toward a vehicle body.

### (Aspect 6)

A method for manufacturing a bumper reinforcement member, the method including:
extruding an aluminum alloy extruded shape material, the aluminum alloy extruded shape material including:
an outer flange and an inner flange separated from each other by a first flange distance in a vehicle front-rear direction; and
a web group including a first web connected to the outer flange at a first outer connection portion and connected to the inner flange at a first inner connection portion, and a second web adjacent to the first web, connected to the outer flange at a second outer connection portion, and connected to the inner flange at a second inner connection portion, wherein the first outer connection portion is separated from the second outer connection portion by an outer web distance shorter than the first flange distance in an in-plane direction of the outer flange, and the first inner connection portion is separated from the second inner connection portion by an inner web distance shorter than the first flange distance in an in-plane direction of the inner flange;
performing crushing processing on both ends of the aluminum alloy extruded shape material so that a distance between the outer flange and the inner flange is reduced to a second flange distance and so that the first web and the second web have protruding shapes facing each other; and
applying precipitation strengthening heat treatment to the aluminum alloy extruded shape material.

### (Aspect 7)

The method for manufacturing a bumper reinforcement member according to the aspect 6, wherein the outer web distance is shorter than the second flange distance, and the inner web distance is shorter than the second flange distance.

### (Aspect 8)

The method according to the aspect 6 or 7, wherein the aluminum alloy extruded shape material is heated to be in a warm state after the aluminum alloy extruded shape material is extruded and before both the ends are subjected to crushing processing.

### (Aspect 9)

The method according to the aspect 6 or 7, wherein the aluminum alloy extruded shape material is subjected to softening heat treatment after the aluminum alloy extruded shape material is extruded and before both the ends are subjected to crushing processing.

This application claims priority based on Japanese Patent Application No. 2022-019654 filed on Feb. 10, 2022. Japanese Patent Application No. 2022-019654 is incorporated herein by reference.

### EXPLANATION OF REFERENCES

1 bumper system
2 bumper beam (bumper reinforcement member)
2a central portion
2b both end portions
3 bumper stay
4 vehicle body
10 outer flange
11 first outer connection portion
12 second outer connection portion
13 third outer connection portion
14 fourth outer connection portion
20 inner flange
21 first inner connection portion
22 second inner connection portion
23 third inner connection portion
24 fourth inner connection portion
30 web group
31 first web
31a first protruding portion
31b notched portion
32 second web
32a second protruding portion
32b notched portion
33 third web
33a third protruding portion
33b notched portion
34 fourth web
34a fourth protruding portion
40A, 40B, 40C, 40D, 40E, 40F fillet
50 extruder
51 bending machine
52 first pressing machine
53 second pressing machine
61 first contact portion
62 second contact portion
63 third contact portion
D1 first flange distance
D2 second flange distance
D3 outer web distance
D4 inner web distance.
D5 protruding portion distance

1. A bumper reinforcement member made of an aluminum alloy extruded shape material extending along a vehicle left-right direction, comprising:
an outer flange and an inner flange separated from each other in a vehicle front-rear direction;
a web group connecting the outer flange and the inner flange;
a central portion in which the outer flange and the inner flange are separated from each other by a first flange distance, the central portion being a portion positioned at a center in the vehicle left-right direction; and
both end portions in which the outer flange and the inner flange are separated from each other by a second flange distance shorter than the first flange distance, each of both the end portions being a portion positioned at either end in the vehicle left-right direction,
wherein the web group includes
a first web connected to the outer flange at a first outer connection portion and connected to the inner flange at a first inner connection portion, and
a second web adjacent to the first web, connected to the outer flange at a second outer connection portion, and connected to the inner flange at a second inner connection portion,
in a vehicle vertical direction, the first outer connection portion is separated from the second outer connection portion by an outer web distance shorter than the first flange distance, and the first inner connection portion is separated from the second inner connection portion by an inner web distance shorter than the first flange distance, and
the first web and the second web are respectively curved so as to have protruding shapes facing each other at both the end portions.

2. The bumper reinforcement member according to claim 1, wherein the outer web distance is shorter than the second flange distance, and the inner web distance is shorter than the second flange distance.

3. The bumper reinforcement member according to claim 1, wherein
the first web includes a first protruding portion closest to the second web at both the end portions,
the second web includes a second protruding portion closest to the first web at both the end portions, and
the first protruding portion and the second protruding portion are respectively positioned at an identical distance from the outer flange in a cross-section perpendicular to an extending direction of the aluminum alloy extruded shape material.

4. The bumper reinforcement member according to claim 3, wherein the first protruding portion and the second protruding portion are in contact with each other.

5. The bumper reinforcement member according to claim 1, wherein both the end portions are bent toward a vehicle body.

6. The bumper reinforcement member according to claim 3, wherein both the end portions are bent toward a vehicle body.

7. The bumper reinforcement member according to claim 4, wherein both the end portions are bent toward a vehicle body.

8. A method for manufacturing a bumper reinforcement member, the method comprising:
extruding an aluminum alloy extruded shape material, the aluminum alloy extruded shape material including:
an outer flange and an inner flange separated from each other by a first flange distance in a vehicle front-rear direction; and
a web group including a first web connected to the outer flange at a first outer connection portion and connected to the inner flange at a first inner connection portion, and a second web adjacent to the first web, connected to the outer flange at a second outer connection portion, and connected to the inner flange at a second inner connection portion, wherein the first outer connection portion is separated from the second outer connection portion by an outer web distance shorter than the first flange distance in an in-plane direction of the outer flange, and the first inner connection portion is separated from the second inner connection portion by an inner web distance shorter than the first flange distance in an in-plane direction of the inner flange;
performing crushing processing on both ends of the aluminum alloy extruded shape material so that a distance between the outer flange and the inner flange is reduced to a second flange distance and so that the first web and the second web have protruding shapes facing each other; and
applying precipitation strengthening heat treatment to the aluminum alloy extruded shape material.

9. The method for manufacturing a bumper reinforcement member according to claim 8, wherein the outer web distance is shorter than the second flange distance, and the inner web distance is shorter than the second flange distance.

10. The method according to claim 8, wherein the aluminum alloy extruded shape material is heated to be in a warm state after the aluminum alloy extruded shape material is extruded and before both the ends are subjected to crushing processing.

11. The method according to claim 8, wherein the aluminum alloy extruded shape material is subjected to softening heat treatment after the aluminum alloy extruded shape material is extruded and before both the ends are subjected to crushing processing.

12. The bumper reinforcement member according to claim 2, wherein
the first web includes a first protruding portion closest to the second web at both the end portions,
the second web includes a second protruding portion closest to the first web at both the end portions, and
the first protruding portion and the second protruding portion are respectively positioned at an identical distance from the outer flange in a cross-section perpendicular to an extending direction of the aluminum alloy extruded shape material.

13. The bumper reinforcement member according to claim 12, wherein the first protruding portion and the second protruding portion are in contact with each other.

14. The bumper reinforcement member according to claim 2, wherein both the end portions are bent toward a vehicle body.

15. The bumper reinforcement member according to claim 12, wherein both the end portions are bent toward a vehicle body.

16. The bumper reinforcement member according to claim 13, wherein both the end portions are bent toward a vehicle body.

17. The method according to claim 9, wherein the aluminum alloy extruded shape material is heated to be in a warm state after the aluminum alloy extruded shape material is extruded and before both the ends are subjected to crushing processing.

18. The method according to claim 9, wherein the aluminum alloy extruded shape material is subjected to softening heat treatment after the aluminum alloy extruded shape material is extruded and before both the ends are subjected to crushing processing.
